(19) United States
(12) Patent Application Publication
(10) Pub. No.: US 2022/0396694 A1
(43) Pub. Date: Dec. 15, 2022

(54) POLYPROPYLENE COMPOSITE RESIN LIGHT DIFFUSION PLATE

(71) Applicant: Chun Nam HWANG, Incheon (KR)

(72) Inventor: Chun Nam HWANG, Incheon (KR)

(21) Appl. No.: 17/777,542

(22) PCT Filed: Nov. 9, 2020
(86) PCT No.: PCT/KR2020/015597

§ 371 Date: May 17, 2022

(30) Foreign Application Priority Data
Dec. 11, 2019 (KR) 10-2019-0164535

(51) Int. Cl. C08L 23/12; G02B 5/02

(52) U.S. Cl. CPC C08L 23/12; G02B 5/0247; C08L 2205/08; C08L 2205/20; C08L 2205/22

(57) ABSTRACT

The present invention relates to a polypropylene composite resin light diffusion plate. The polypropylene composite resin light diffusion plate obtained by mixing hollow spheres made of an inorganic material with an eco-friendly, inexpensive, low specific gravity polypropylene composite resin can improve thermal expansion characteristic (area expansion rate) to a level equal to or superior to those of polycarbonate (PC) and polystyrene (PS), enhance optical characteristics (transmittance, shielding rate), and reduce manufacturing costs. The polypropylene composite resin light diffusion plate according to the present invention is manufactured in a flat plate shape by mixing a plurality of hollow spheres with a polymer resin containing a polypropylene (PP) resin and has an area expansion rate of 0.4-0.7% at 60° C., relative to an area at room temperature, due to mutual bonding of the polypropylene (PP) resin and the plurality of hollow spheres by covalent bonding therebetween.

### TECHNICAL FIELD

The present disclosure relates to a light diffusing plate, and more particularly, to a polypropylene composite resin light diffusing plate which can improve the high thermal expansion characteristic (i.e., the greatest disadvantage of polypropylene resin) through covalent binding with hollow spheres and increase optical performance.

### BACKGROUND ART

A light diffusing plate is a plate manufactured by extrusion after adding a light diffusing agent to a plastic material by adding. The light diffusing plate is an optical component material whose main functions include shielding the point light source of LED and serving as a surface light source, and is used in various ways such as LED lighting or advertising channel signs, displays, etc.

The main materials used for the light diffusing plate include polycarbonate (PC) and polystyrene (PS).

Polycarbonate (PC) and polystyrene (PS), which are materials used in the existing light diffusing plates, are non-crystalline materials with a chain structure, which have a shrinkage rate of 7/1,000% or less, a low linear expansion coefficient of 70×10⁻⁶/K to 75×10⁻⁶/K, in which the polymer arrangement is in a chain structure, and the dimensions are stable. Polystyrene (PS) is cheaper than polycarbonate (PC), but it has disadvantages in that it is easily broken (brittle) due to its low impact strength, and that although it is manufactured using benzene (i.e., an aromatic compound) and is thus a hydrocarbon such as polypropylene (PP), but is not eco-friendly. Polycarbonate (PC) is the best in almost all mechanical properties, but it has disadvantages in that it is manufactured using bisphenol A (i.e., an environmental hormone) and phosgene (i.e., a representative toxic gas) and is thus also not eco-friendly and its cost is the highest.

A polypropylene (classified as homo polymer, random-copolymer, impact-copolymer and called PP) material, compared to other materials, has a lower specific gravity, has the cheapest material price, and is purely a conjugate of carbons and hydrogens thus being considered as eco-friendly, and has excellent mechanical properties. PP is a non-polar material, crystalline, and hydrophobic, and cannot be adhered to other materials. For example, in the case of a sign product using LED as a light source, there is a case where sheets of various colors may be adhered to the upper surface of the plate depending on the need and purpose, whereas in the case of PP, the adhesive strength due to hydrophobicity is relatively low, and is easily separated from the sheet, thus making it unsuitable for use. In contrast, in the case of lighting or displays using LED as a light source, these hydrophobic properties have the advantage of being relatively free from dust or contamination compared to other materials when used for a long period of time.

PP is translucent, non-polar, hydrophobic, and is a plastic material having the highest linear expansion coefficient of 100×10⁻⁶/K to 200×10⁻⁶/K among plastics.

Meanwhile, in order to make a light diffusing plate from a material such as polycarbonate (PC), polystyrene (PS), or polypropylene (PP), the light diffusing plate is manufactured through an extrusion process. Since machine direction (MD) and transverse direction (TD) act on the extrusion process, a thermal expansion characteristic (an area expansion rate), which measures the change in the area of the finished product of the extruded light diffusing plate, is applied rather than applying the standard of the linear expansion coefficient of the material.

However, the thermal expansion characteristic (area expansion rate) of the light diffusing plate made of a PP material is close to a two-fold that of the existing PC- and PS light diffusing plates in the reliability tests performed under the environmental conditions of 60° C.; therefore, there is a problem in that it is difficult to apply the light diffusing plate made of a PP material for use as a light diffusing plate of a device that uses LED as a light source, such as channel-sign and display products.

As such, conventionally, in order to remedy the high thermal expansion characteristic of the light diffusing plate made using a PP material, there was suggested a method of filling the PP resin with an inorganic material such as glass fiber, mica, talc, calcium carbonate, and hollow beads. However, when an inorganic material is merely filled into the PP resin, there is a problem in that the inorganic material and the PP resin cannot be combined with each other, and thus the effect of improving the thermal expansion characteristic is significantly reduced and the mechanical strength thereof is also reduced.

### DISCLOSURE

### Technical Problem

The present disclosure is to solve the problems described above, and an object of the present disclosure is to provide a polypropylene composite resin light diffusing plate by mixing hollow spheres made of an inorganic material with an eco-friendly, inexpensive, low specific gravity polypropylene composite resin, which can improve thermal expansion characteristic (area expansion rate) to a level equal to or superior to those of polycarbonate (PC) and polystyrene (PS), enhance optical characteristics (transmittance, shielding rate), and reduce manufacturing costs.

### Technical Solution

To achieve the above object, the polypropylene composite resin light diffusing plate according to the present disclosure is manufactured in a flat plate shape by mixing a plurality of hollow spheres with a polymer resin containing a polypropylene (PP) resin, in which the polypropylene (PP) resin and the plurality of hollow spheres are bonded to each other by covalent bonding, and thereby the resultant has an area expansion rate of 0.4-0.7% at 60° C. relative to an area at room temperature.

The volume ratio (vol %) of the polymer resin is 82-96 vol %, and the volume ratio (vol %) of hollow spheres is 4-18 vol %.

For the hollow spheres, glass beads with a density of 0.3-0.9 g/cm³ and an average outer diameter of 1-300 μm may be used.

The polymer resin and the hollow spheres may be covalently bonded by mixing with a compatibilizer.

In particular, the compatibilizer may be modified propylene, in which one or more kinds selected from the group consisting of maleic anhydride, acrylic acid and methacrylic acid is grafted onto a polypropylene resin and has a graft rate of 0.3-1.0%, and may be used in an amount of 0.2-5 wt % based on 100 wt % of the composition constituting the entire light diffusing plate.

Additionally, for the covalent bonding between the polymer resin and the hollow spheres, the hollow sphere may be surface-treated by hydrolyzing an aminosilane coupling agent.

In particular, a compatibilizer may be further mixed to the polymer resin.

The aminosilane coupling agent is preferably used in an amount of 0.1-0.7 wt % in the hydrolysis process.

Alternatively, for covalent bonding between the polymer resin and the hollow sphere, as hollow spheres, plasma surface-treated hollow spheres may be used.

### Advantageous Effects

According to the present disclosure, the polypropylene (PP) resin of the polymer resin is mutually bonded with hollow spheres through a covalent bond to have high tensile strength and simultaneously have an area expansion rate equivalent to that of a PC light diffusing plate.

Additionally, the resultant meets the optical properties, that is, the shielding rate (haze) of 92-99% and the total-light transmittance (TT) of 35-70%, thus having suitable performance as a product for a light diffusing plate.

### DESCRIPTION OF DRAWINGS

FIG. 1 is a cross-sectional view and an enlarged cross-sectional view schematically illustrating the configuration of a light diffusing plate according to an embodiment of the present disclosure.

FIG. 2 is a view for explaining the area expansion rate of the light diffusing plate.

FIGS. 3 and 4 each show a scanning electron microscope (SEM) image of a light diffusing plate in which glass fibers are covalently bonded to a polypropylene resin.

FIGS. 5 and 6 each show a SEM image of a light diffusing plate prepared by mixing a compatibilizer and hollow spheres with a polypropylene resin.

FIG. 7 shows a SEM image of a light diffusing plate prepared by mixing a polypropylene resin and a compatibilizer with silane-coated hollow spheres.

FIG. 8 shows a SEM image of a light diffusing plate in which a polypropylene resin and silane-coated hollow spheres are mixed.

FIGS. 9 and 10 each show a SEM image of a light diffusing plate in which a covalent bond between a polypropylene resin and hollow spheres is realized merely by adding a compatibilizer thereto.

FIGS. 11 and 12 each show a SEM image of a light diffusing plate prepared by mixing a polypropylene resin, a compatibilizer, and plasma-coated hollow spheres.

FIG. 13 shows a SEM image of a light diffusing plate in which a polypropylene resin and plasma-coated hollow spheres are covalently bonded.

FIGS. 14 and 15 each show an image observed by SEM of a cross-section of a light diffusing plate (Comparative Example), in which hollow spheres (which are not surface-modified) were used in a polypropylene resin, without adding a compatibilizer thereto.

FIGS. 16 and 17 each show glass transition temperature (Tg) values measured by differential scanning calorimetry (DSC).

FIGS. 18 and 19 each show tests for confirming the interaction between hollow spheres and a polypropylene resin by confirming the viscoelastic behaviors of a light diffusing plate, in which hollow spheres are covalently bonded, and the original polymer PP.

### MODE FOR INVENTION

The examples described in this specification and the configurations illustrated in the drawings are merely preferred embodiments of the disclosed invention, and there may be various modified embodiments that can replace the examples and drawings of this specification at the time of filing of the present application.

Hereinafter, with reference to the accompanying drawings, the polypropylene composite resin light diffusing plate and the manufacturing method thereof according to the present disclosure will be described in detail according to the embodiments described below.

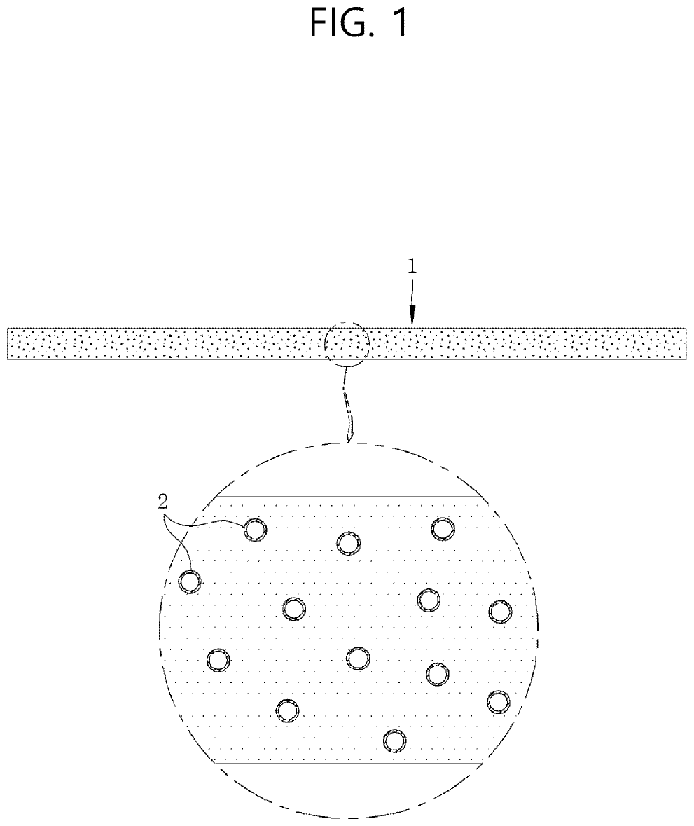

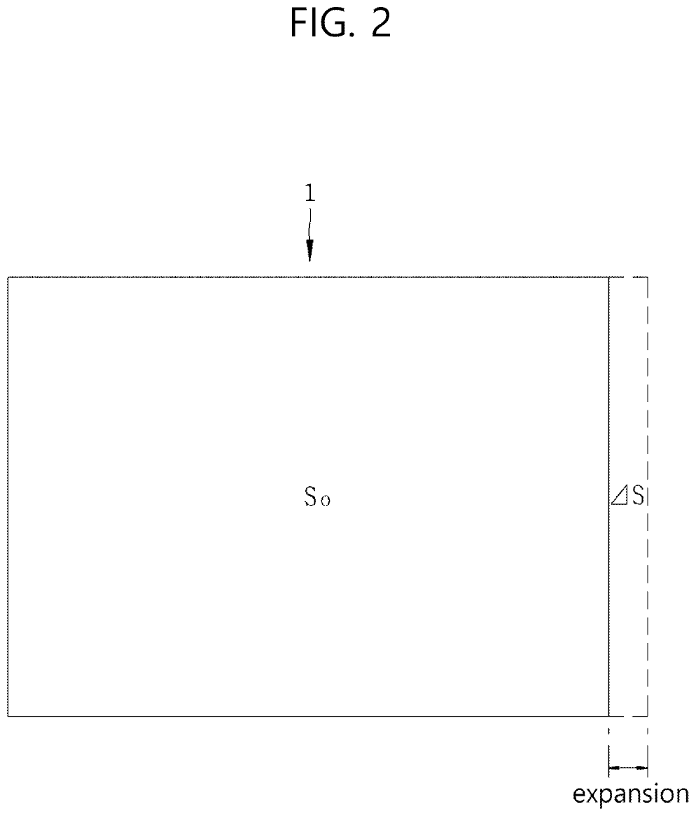

Referring to FIGS. 1 and 2, the light diffusing plate 1 according to an embodiment of the present disclosure is manufactured such that a polypropylene (PP) resin, as a polymer resin, and a plurality of hollow spheres 2 are mixed in a predetermined volume ratio (vol %) followed by extrusion the mixture in the form of a flat plate which has an area expansion rate of 0.4-0.7% by way of controlling the thermal expansion characteristic due to a covalent bonding between the polymer resin and the hollow spheres 2.

Here, the area expansion rate refers to the ratio of the amount of expansion (ΔS) to the initial area (S₀) before heat is applied to the light diffusing plate 1 as shown in the following equation.

area expansion rate (%)=amount of expansion(ΔS)/initial area(S₀)×100

The light diffusing plate 1 provides a characteristic of converting a point light source of a light source (e.g., LED) into a surface light source through scattering of visible light and diffuse reflection of refraction. The light diffusing plate 1 according to the present disclosure has a shielding rate (Haze) of 92-99% and a total light transmittance (TT) of 35-70%. Additionally, the glass transition temperature (Tg) region of the light diffusing plate 1 is preferably −11° C. to 5° C. When the shielding rate (haze) of 92-99% and total-light transmittance (TT) of 35-70% are not satisfied, it cannot be used as a light diffusing plate.

The polymer resin may be made of a polypropylene (PP) resin alone or may be made by including a compatibilizer and/or additive to the polypropylene resin. As the polypropylene (PP) resin, a homopolymer, an impact copolymer, and a random copolyme may be used alone or in combination of one or more.

As the additive, an antioxidant, a processing lubricant, a UV stabilizer, a long-term heat-resistant stabilizer, an antistatic agent, a flame retardant, and a colorant may be additionally used alone or in combination, depending on the purpose of application.

Molecular weight and melt flow-index (melt index; MI) are inversely proportional. When the molecular weight is high, it results in lower MI and improved mechanical properties (e.g., rigidity, uniformity, chemical resistance, etc.), but the flowability becomes low thus lowering productivity during extrusion molding. In contrast, when the molecular weight is low, the opposite the opposite properties are shown.

The hollow spheres 2 are mixed with the polypropylene (PP) resin and covalently bonded to thereby control the thermal expansion characteristic of the light diffusing plate 1 and serve to increase the light diffusion function. The hollow spheres 2 are composed of three-dimensional hollow beads having a thin wall, in which the density is 0.3-0.9 g/cm³ and the average outer diameter is about 1-300 μm. As the hollow spheres 2, one which is made of soda-lime-borosilicate glass may be used. When the particle diameter of the hollow spheres 2 exceeds 300 μm, the light diffusion function is remarkably deteriorated, and may be removed as foreign materials in the process of manufacturing the light diffusing plate 1. Specifically, in the process of manufacturing the light diffusing plate 1, a mesh network is installed on the front and rear sides of the screen of the extruder to filter out foreign materials or carbides generated at high temperature during extrusion so as to remove foreign materials. In this case, the pore spacing of the mesh network is about 300 μm; therefore, when the particle diameter of the hollow spheres 2 exceeds 300 μm, they are filtered by the mesh network.

When the specific gravity of the hollow spheres 2 is less than 0.3 g/cm³, the compressive crushing strength of the product is lowered and partially crushed by the pressure generated in the cylinder when the compound or plate is extruded, and it is difficult to secure shrinkage and expansion, physical strength, and improvement of the light diffusion function of the light diffusing plate to be achieved in the present disclosure.

The material of the hollow spheres 2 is a glass material, and specifically silicate-based glass containing silicic acid (SiO₂) as a main component; borosilicate-based glass containing silicic acid (SiO₂) and boric acid (B₂O₃) as main components, or a phosphate-based glass containing metaphosphate of various metals instead of the silicate contained in the silicate-based glass. The silicate-based glass, which contains silicic acid (SiO₂) as a main component, contains quartz glass, potassium-lime glass in which a part of the sodium in sodium-lime-silicate glass (soda-lime glass or soda-lime-silicate glass) is substituted with potassium, soda-lime glass, lead glass in which lead oxide is contained as a part of the component of potassium-lime glass, etc. The soda-lime glass or soda-lime-silicate glass, which is a representative glass of the silicate-based glass, is glass which contains network modifying ions and sodium, and its molecular composition is Na₂O·Ca O·5-6SiO₂. The borosilicate-based glass contains soda-lime-borosilicate glass, in which soda-lime is further added in addition to silicic acid and boric acid, etc. Preferably, the glass may be borosilicate-based glass, more preferably soda-lime-borosilicate glass in consideration of high crushing strength, etc. The soda-lime-borosilicate glass contains NaO, CaCO, B₂O₃, and SiO₂ components, and composition ratios thereof.

The hollow spheres (2) preferably have a crushing strength of at least 5,000 psi (351.5 kgf/cm²), and this is to prevent crush caused by external factors, such as pressure generated inside the cylinder of the extruder during extrusion. When the hollow spheres 2 are crushed, the covalent bonding rate between the resin and the hollow spheres is significantly lowered, and the light diffusion function is lowered, which ultimately has an adverse effect on the mechanical properties and optical properties of the light diffusing plate 1.

The hollow spheres 2 have a spherical shape and are covalently bonded to the polypropylene (PP) resin (i.e., a polymer resin) so that the attractive force acts in the 360° direction through interaction, so that the expansion of the light diffusing plate 1 is uniformly controlled in the horizontal and vertical directions, rather than in one direction, thereby acting to allow the light diffusing plate 1 to maintain excellent flatness. Additionally, it was confirmed that since the hollow spheres 2 have a particle diameter within 1-300 μm, they have a light diffusion function to refract and scatter visible light, thus increasing the shielding rate. As in the related art, when the light diffusing plate 1 is manufactured merely by mixing the hollow spheres 2 with the polypropylene (PP) resin without covalent bonding, the hollow spheres 2 cannot interact with the polypropylene resin, and thus, there would be almost no effect of improving the area expansion rate of the diffusion plate 1.

In order for the light diffusing plate of the present disclosure to have a desired level of area expansion rate, it is preferred that the volume ratio (vol %) of the polymer resin including the polypropylene (PP) resin be 82-96 vol %, and the hollow spheres 2 be 4-18 vol %.

The covalent bonding between the hollow spheres 2 and the polypropylene resin (i.e., a polymer resin) is performed such that the oxygen atoms (0) of the hollow spheres (2) and the hydrogen atoms (H) of the polypropylene (PP) resin are interchanged to be bonded, in which in the process of manufacturing the diffusion plate 1, the polypropylene resin is melted at 150-300° C. and molded by extrusion, and in particular, the covalent bond with the hollow spheres 2 is formed while the ion exchange is performed.

The covalent bonding between the hollow spheres 2 and the polypropylene resin may be formed by the following three methods.

First, the covalent bonding may be formed by mixing a polypropylene resin, hollow spheres 2, and a compatibilizer. Second, the covalent bonding may be implemented by surface-modification of the hollow spheres 2 with silane. Third, the hollow spheres 2 may be covalently bonded to the polypropylene (PP) resin by neutralizing the surface of the hollow spheres 2 through plasma treatment.

1. Method of Covalent Bonding Using Compatibilizer

First, the covalent bonding using the compatibilizer is a bonding between the oxygen atoms (O) of the hollow spheres (2) and the hydrogen atoms (H) of the polypropylene (PP) resin through interchange.

The compatibilizer is modified polypropylene, in which one or more selected from the group consisting of maleic anhydride, acrylic acid, and methacrylic acid is grafted onto a polypropylene resin and having a graft rate of 0.3-1.0%, and the modified polypropylene is used in an amount of 0.2-5 wt % based on 100 wt % of the composition constituting the entire light diffusing plate.

2. Method of Silane Treatment on Surface of Hollow Spheres

The interface of the hollow spheres 2 are coated with silane and the surface of the hollow spheres 2 are treated by hydrolyzing an aminosilane coupling agent with a long methyl group. Specifically, silane is added to butanol/distilled water, hydrolyzed to modify the surface of the hollow spheres 2, and the hollow spheres 2 are dried under reduced pressure to thereby obtain the surface-modified hollow spheres 2.

However, as silane is an organic material, it is possible that in the hollow spheres 2, which are surface-treated by hydrolysis, silane may change the color of the light diffusing plate 1 due to the yellowing phenomenon in the extrusion process at high temperature. Conventionally, the concentration of silane during hydrolysis is set at about 1-5 wt %; however, in the present disclosure, the concentration of silane is used as 0.1-0.7 wt %, thus proposing a method for modifying the surface of hollow spheres 2 without generating the yellowing phenomenon.

The reactive silanes that can be used for surface modification of the hollow spheres 2 for covalent bonding between the hollow sphere 2 and the polymer resin may include aminosilanes (e.g., 3-aminoethyl triethoxysilane, 3-aminopropyl triethoxysilane, 3-aminopropyl trimethoxysilan, etc.), isocyanate silanes (e.g., 3-isocyanatopropyl triethoxysilane, 3-carboxypropyltrimethoxy silane, etc.), carboxy silanes (e.g., 3-carboxypropyltriethoxy silane, 3-carboxypropyltrimethoxy silane, etc.), and hydroxysilanes (e.g., 3-hydroxypropyltriethoxy silane, 3-hydroxypropyltrimethoxy silane, etc.), but are not limited thereto.

3. Method for Surface Modification Through Plasma Treatment

Plasma surface treatment is to form a covalent bond with non-polar polypropylene by neutralizing the surfaces of hollow spheres.

After positioning the electrode of the plasma generating device and the hollow spheres 2 to be treated to be at a distance of 0.1-10 mm, an inert gas is injected into the plasma generating device at a flow rate of 1-20 L/min, and the surface of the hollow spheres is heated at room temperature and atmospheric pressure and thereby neutralizes the surfaces of hollow spheres 2.

When the surfaces of the hollow spheres 2 are treated with plasma as described above, the surfaces of the hollow spheres 2 are modified to thereby improve their adhesion property with the polypropylene resin.

### Test Example 1: Suitability Test for Each Inorganic Material

In order to improve the thermal expansion of the polypropylene composite resin light diffusing plate, suitability tests were performed for various inorganic materials.

First, various inorganic materials include mica, talc, calcium carbonate, glass fiber (GF) with a diameter of 12 μm and a length of 1-5 μm or less, and hollow spheres made of soda-lime borosilicate glass with an average outer diameter of 50 μm (H38 product of ZH (China)) were prepared.

As a compatibilizer, modified polypropylene in which 1 wt % of maleic anhydride was added and having a graft rate of 0.5% was used, and the inorganic materials prepared above were added to each homopolypropylene resin to prepare a composite composition. Additionally, in order to maintain the thermal stability of the polymer, primary and secondary antioxidants (Adeca primary and secondary) were added in an amount of 0.1 wt %, respectively.

In Table 1 below, the polypropylene resin used in Samples 1-1 and 1-10 are the products of GSC, and the modified PP is a product of Chemco's MP120pp; as an inorganic material, in Samples 1-1 and 1-2, mica (manufacturer; Coch) was added at 4 wt % or 8 wt %; in Samples 1-3 and 1-4, talc (manufacturer; Seokyung) was added at 4 wt % or 8 wt %; and in Samples 1-5 and 1-6, calcium carbonate (manufacturer; Coch) was added at 4 wt % or 8 wt %, and in Samples 1-7 and 1-8, glass fiber (manufacturer; NEG (Japan)) was added at 4 wt % or 8 wt %, and in Samples 1-9 and 1-10 (manufacturer; ZH (China)) was added at 4 wt % or 8 wt %.

TABLE 1

| | Name of | | | Anti- | Inorganic |
|---|---|---|---|---|---|
| Sample | Inorganic | | Compatibilizer | oxidant | Material |
| No. | Material | pp (wt %) | (wt %) | (wt %) | (wt %) |
| PP | X | 99.8 | X | 0.2 | |
| Alone | | | | | |
| Sample | mica | 93.8 | 2 | 0.2 | 4 |
| 1-1 | | | | | |
| Sample | | 89.8 | 2 | 0.2 | 8 |
| 1-2 | | | | | |
| Sample | talc | 93.8 | 2 | 0.2 | 4 |
| 1-3 | | | | | |
| Sample | | 89.8 | 2 | 0.2 | 8 |
| 1-4 | | | | | |
| Sample | calcium | 93.8 | 2 | 0.2 | 4 |
| 1-5 | | | | | |
| Sample | carbonate | 89.8 | 2 | 0.2 | 8 |
| 1-6 | | | | | |
| Sample | | 93.8 | 2 | 0.2 | 4 |
| 1-7 | glass fiber | | | | |
| Sample | | 89.8 | 2 | 0.2 | 8 |
| 1-8 | | | | | |
| Sample | hollow | 93.8 | 2 | 0.2 | 4 |
| 1-9 | | | | | |
| Sample | spheres | 89.8 | 2 | 0.2 | 8 |
| 1-10 | | | | | |

The composite compositions for a light diffusing plate having the composition of Table 1 were tested by the following methods (1), (2), (3), and (4) so as to confirm the performance of each inorganic material.

(1) Measurement of Tensile Strength

The Sample compositions 1-1 to 1-10 of Table 1 were mixed in a mixer, and injected into the main-hopper of a twin-screw extruder set at a temperature of 160° C. to thereby prepare each composite material for the light diffusing plate. After drying them for 24 hours in a dryer, light diffusing plate specimens were prepared according to ASTM D-638 standard using an injection machine. Tensile strength was measured for each of the light-diffusing plate specimens prepared above using a tensile tester (UTM).

(2) Measurement of Area Expansion Rate

The composite materials for the light diffusing plate prepared for the tensile test of (1) above were each put into a mold of width (50 mm)×length (146.5 mm)×thickness (1.35 mm), and hot-pressed to prepare a light-diffusing plate sample. After cuing the prepared samples at 20° C. for 24 hours in a chamber, the length was measured with an electronic micrometer. Thereafter, the temperature of the chamber was raised to 60° C., pulled in for 24 hours, and the changed length of each specimen was measured so as to measure the area change rate according to temperature.

(3) Analysis of SEM Images

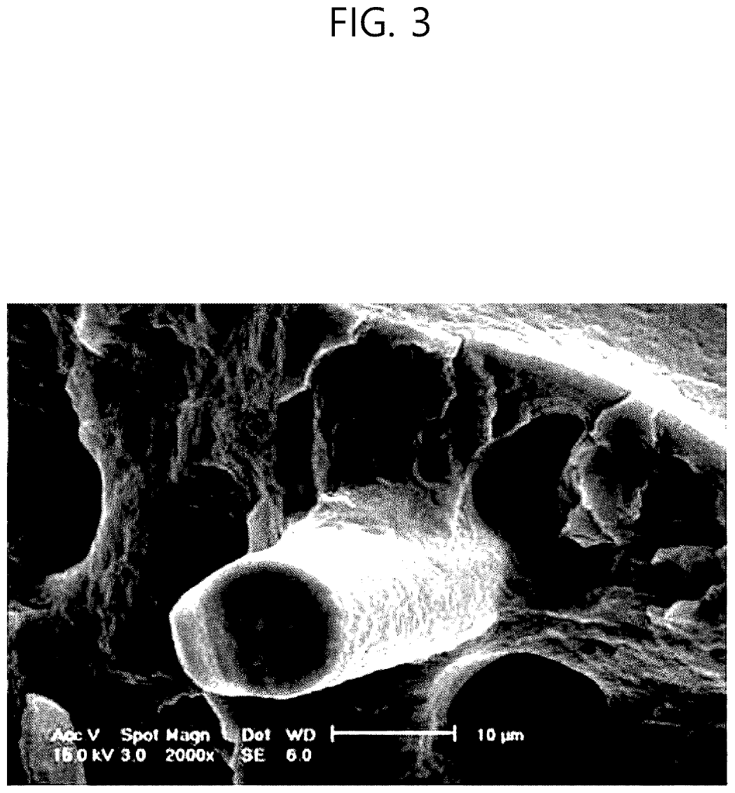

After selecting specimens with excellent results in the tensile test and area expansion rate measurement (refer to the test results in Table 2), the light diffusing plate Samples were cooled with liquid nitrogen and then fractured, and the cross-sections were photographed by SEM and the presence of covalent bonding was examined. The photographed images are shown in FIGS. 3 to 13.

(4) Measurement of Shielding Rate and Total Light Transmittance

The total light transmittance (%) and the shielding rate (haze) were measured for the light diffusing plate specimens of Samples 1-9 and 1-10 prepared in the measurement of the area expansion rate using a BM-7 colorimeter (TOPCON) and a spectral luminance meter (Photo Research, Inc.), respectively. The measured results are shown in Table 2 below.

Table 2 below shows the test results of the tensile test, area expansion rate measurement, shielding rate, and total light transmittance measurement described above.

TABLE 2

| | | | Area | | |
|---|---|---|---|---|---|
| | | | Expansion | Total | |
| | | Tensile | Rate | Light | |
| | Inorganic | strength | 60° C. | Trans- | Shielding |
| Ingredient | Material | (kgf/cm²) | (%) | mittance | Rate |
| PP based | none | 351.02 | | | |
| Sample 1-1 | mica | 335.71 | X | X | X |
| Sample 1-2 | mica | 337.43 | X | X | X |
| Sample 1-3 | talc | 332.64 | X | X | X |
| Sample 1-4 | talc | 330.75 | X | X | X |
| Sample 1-5 | calcium | 324.28 | X | X | X |
| | carbonate | | | | |
| Sample 1-6 | calcium | 316.31 | X | X | X |
| | carbonate | | | | |
| Sample 1-7 | glass fiber | 367.63 | 1.07 | | |
| Sample 1-8 | glass fiber | 385.82 | 1.03 | | |
| Sample 1-9 | hollow | 360.92 | 0.62 | 60.94 | 98.73 |
| | spheres | | | | |
| Sample 1-10 | hollow | 361.98 | 0.58 | 41.59 | 98.83 |
| | spheres | | | | |

Reviewing the results of the tensile strength test in Table 2, it was confirmed that the inorganic materials of Samples 1-1 to 1-6 had lower tensile strength values than the PP reference value. It is analyzed that this is because there is almost no effect of increasing the tensile strength when covalent bonds are not formed even if an inorganic material is mixed. Therefore, Samples 1-1 to 1-6 were excluded from (2), (3), and (4) tests.

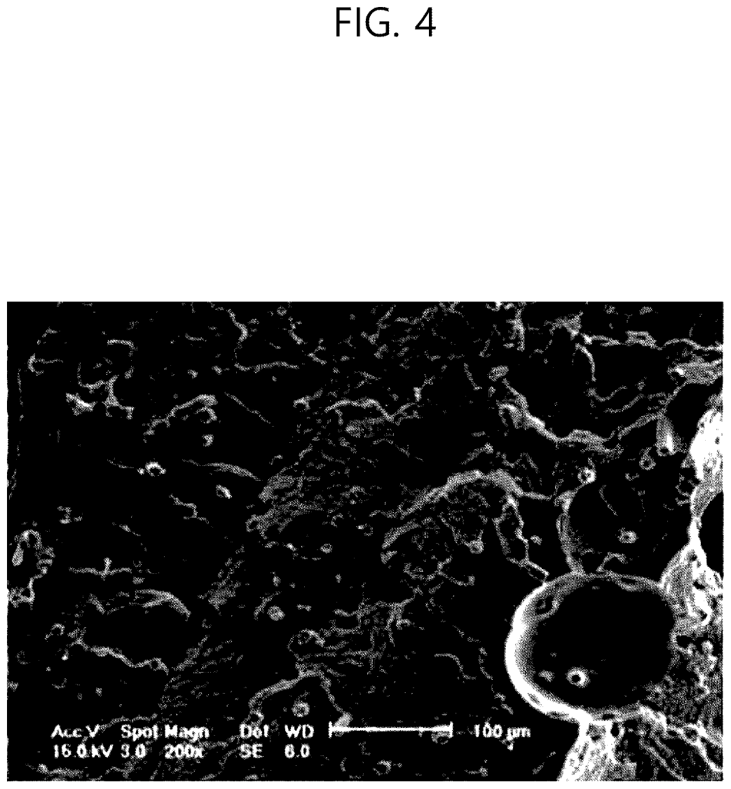

Additionally, as a result of scanning electron microscope (SEM) photographing, as shown in the test results of FIGS. 3 and 4, it can be confirmed that Samples 1-7 and 1-8 containing glass fibers have good covalent bonding with the matrix. As a result, it can be confirmed from the scanning electron microscope (SEM) images and the tensile test results in Table 2 that the mechanical properties were improved and the light transmittance was also good.

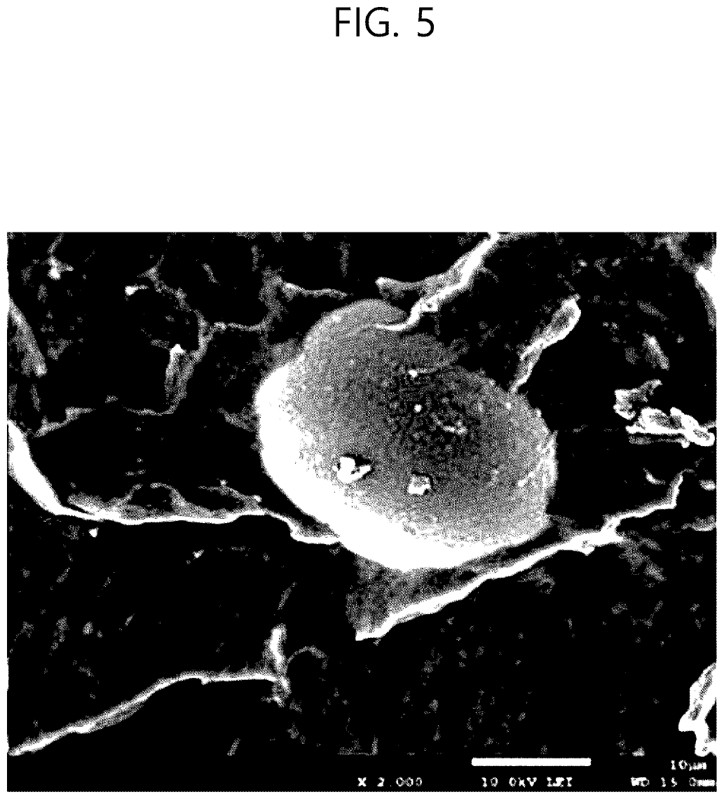

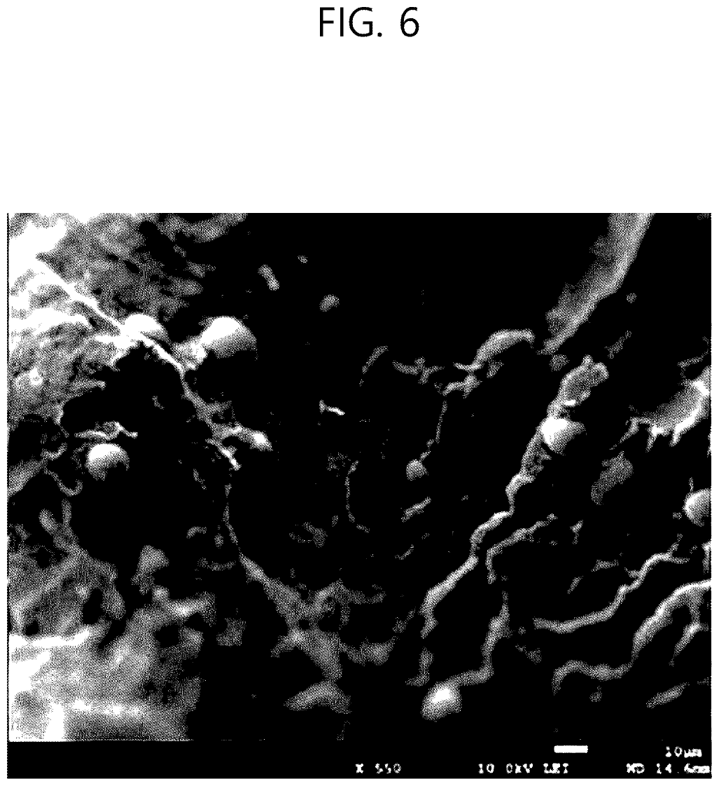

Additionally, it was confirmed that Samples 1-9 and 1-10 containing hollow spheres were also well covalently bonded to the PP resin through the tensile test results in Table 2 and the SEM images of FIGS. 5 and 6.

As a result of measuring the area expansion rate, the area expansion rates of Samples 1-7 and 1-8 (glass fibers) were 1.07% and 1.03%, respectively, and Samples 1-9 and 1-10 (hollow spheres) were 0.62% and 0.58%, respectively. Although the tensile and SEM results of the two inorganic materials were excellent, the areal expansion coefficients showed opposite results, and eventually, it was confirmed that the hollow sphere was the most suitable material for improving the thermal expansion characteristics of the light diffusing plate. The reason for causing the difference in the area expansion rate can be confirmed in Example 5.

### Test Example 2: Optical Characteristics of Light Diffusing Plate Containing Hollow Spheres

In order to confirm the optical properties of the light diffusing plate including hollow spheres, the composite material of the light diffusing plate prepared by mixing according to Samples 2-1, 2-2, and 2-3 in Table 3 followed by compounding with a twin-screw extruder was prepared. Thereafter, samples for the light diffusing plate were prepared by hot-pressing on a mold of width (50 mm)×length (146.5 mm)×thickness (1.35 mm). The PP described in [Table 4] is impact-copolymer (BP2200) PP (which is a product of Korea Petrochemical Ind. Co., Ltd.), and the hollow spheres have an average particle diameter of 30 micrometers and soda-lime-borosilicate glass (3M) with a specific gravity of 0.60.

TABLE 3

| | Sample 2-1 | Sample 2-2 | Sample 2-3 |
|---|---|---|---|
| | (wt %) | (wt %) | (wt %) |
| PP | 95 | 93 | 90 |
| Modified PP | 2 | 2 | 2 |
| Hollow Spheres | 3 | 5 | 8 |
| Haze (D1003-97) @ | 98.51% | 98.73% | 98.84% |
| (shielding rate) | | | |
| Y(C) (Transmittance | 62.29% | 58.02% | 41.59% |
| Rate) | | | |

Shielding rate (haze) measurement: BM-7 colorimeter (TOPCON), Transmittance (Yc) measurement: spectroluminance meter (Photo Research, Inc.)

Judging from the test results in Table 3, it can be confirmed that the optical performance of the light diffusing plate including the hollow spheres is equivalent to the optical characteristics (having 92-99% of haze and 35-70% of the total light transmittance) possessed by the PS and PC optical diffuser plates, which are existing mass-produced products.

### Test Example 3: Method for Covalent Bonding Between Hollow Spheres and Polypropylene (PP) Resin

### Example 3-1 Modification of Surface of Hollow Spheres Using Silane and Use of

### Compatibilizer

The hollow spheres used in the test were soda-lime borosilicate glass beads (3M S60) with an average outer diameter of 30 μm and a density of 0.60 g/cm³, and GS Caltex Homo H710 was used as the PP resin.

The interfaces of the hollow spheres were coated with silane such as an aminosilane coupling agent having a long methyl group and a compatibilizer was added to the PP resin together with the modified PP. More specifically, the surfaces of the hollow spheres were treated by hydrolyzing an aminosilane coupling agent having a long methyl group. Specifically, amino-based silane (0.5 wt % in weight ratio, Dow Chemical) was added to butanol/distilled water (99.5 wt % in weight ratio), which was adjusted to pH 3.5, and hydrolyzed for one hour so as to modify the surfaces of hollow spheres (CENO Tech). The resultant was placed under reduced pressure again and dried in a dryer at a temperature of 120° C. for 12 hours to thereby obtain surface-modified hollow spheres.

As a compatibilizer for covalent bonding of the hollow spheres (whose surfaces were treated with silane) and polypropylene, 2 wt % of modified polypropylene (in which 1 wt % of maleic anhydride was grafted with polypropylene and which has a graft rate of 0.5%) was added and compounded with polypropylene resin and hollow spheres.

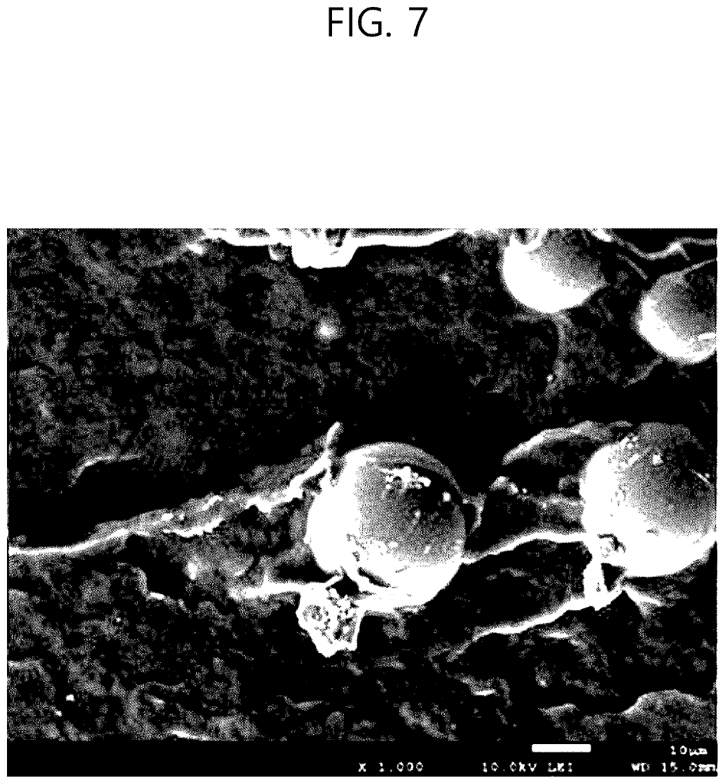

A material, in which 90 wt % of PP (H710, GS Caltex) and 2 wt % of modified pp (to which maleic anhydride was grafted for covalent bonding) as a compatibilizer were mixed, was injected into the main feeder hopper of a twin-screw extruder, and 8 wt % of interfacially-modified hollow spheres were injected into a side feeder hopper, respectively, and compounded. During the compounding process, a 100 mm-long strand was cut, and the cut strand was cooled in liquid nitrogen at −180° C. and fractured, and the cross-section was scanned using a scanning electron microscope (SEM) to observe interfacial bonding (see FIG. 7).

As illustrated in FIG. 7, as a result of the test, it can be confirmed that the covalent bonding between the hollow spheres and the PP resin was perfectly achieved.

Five tensile specimens were respectively prepared from the raw material prepared as such according to ASTM D638 standard through an injection machine, and after 48 hours at room temperature, the tensile strength was measured for each specimen using a tensile tester (UTM), and the average value was obtained. The test result values are shown in Table 4 below.

### Example 3-2 Non-Use of Compatibilizer

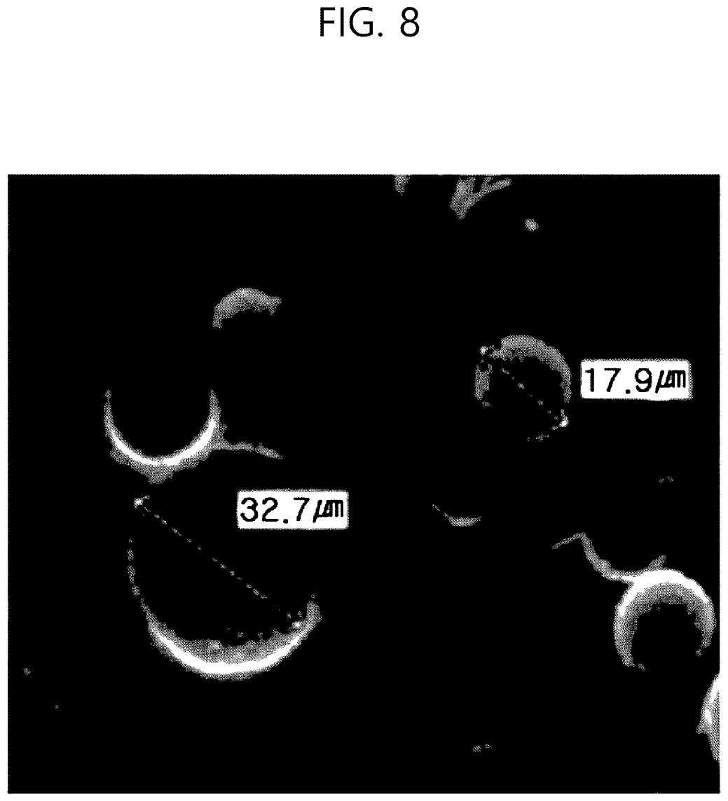

In Example 3-2, hollow spheres coated with silane on the interfaces were used in the same manner as in Example 3-1, but without using a compatibilizer, and the content of PP (H710, GS Caltex) was changed to 92 wt %, prepared in the same manner as in Example 3-1, 100 mm-long strands were cooled in liquid nitrogen at −180° C. and fractured, and their cross-sections were observed for interfacial bonding with a scanning electron microscope (SEM) (see FIG. 8).

### Example 3-3 Use of Compatibilizer

In Example 3-3, hollow spheres without surface modification and a PP resin were used, and covalent bonding was attempted using the modified PP of Example 3-1 as a compatibilizer.

Specifically, the mixing ratio set as a weight ratio was such that while PP (90 wt %) and modified PP (2 wt %) were mixed in the main hopper, hollow spheres (8 wt %) were placed in the side feeder hopper and compounded, during the process of which the resultant was cut into 100 mm-length strands, cooled in liquid nitrogen, and fractured, and their cross-sections were observed for covalent bonding with a scanning electron microscope (SEM).

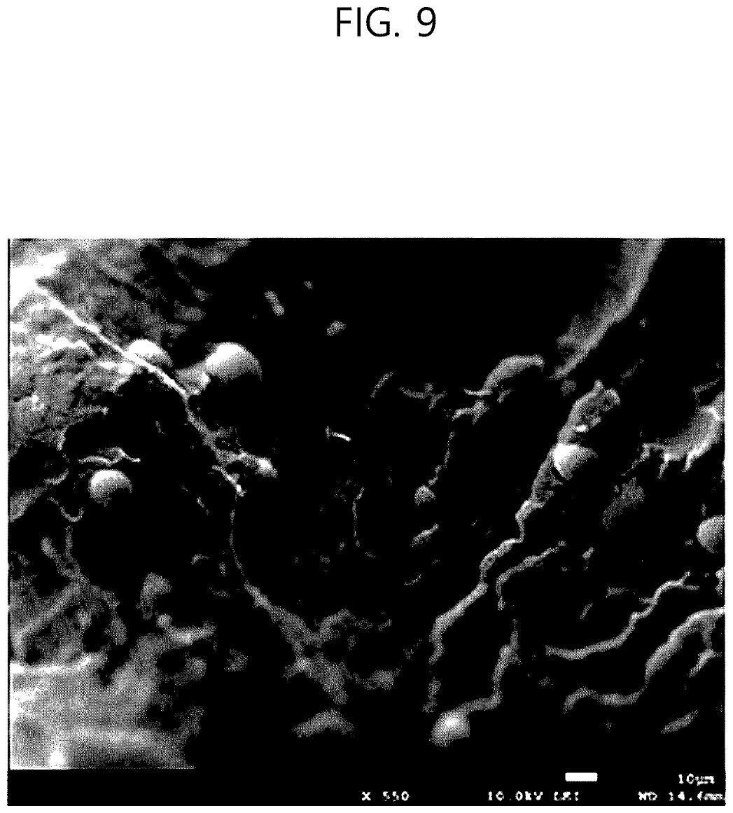

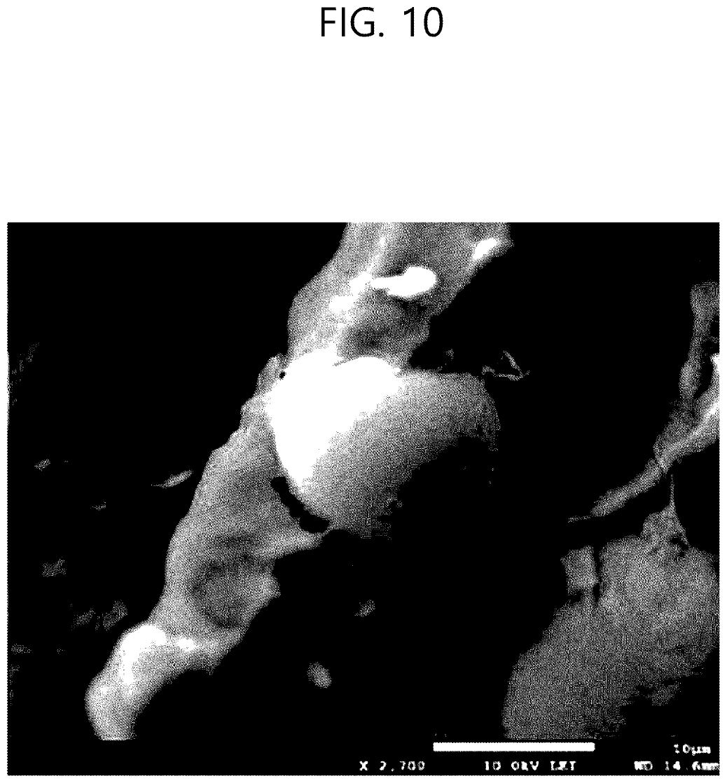

As shown in FIGS. 9 and 10, it can be confirmed as a result of the test that the covalent bonding was well formed between the hollow spheres and the polypropylene resin.

Five tensile specimens were prepared from the raw materials prepared according to ASTM D638 standard through an injection machine, respectively, and after placing them at room temperature for 48 hours, the tensile strength of each specimen was measured using a tensile tester (UTM), and the average value was obtained. The results of this test are shown in Table 4.

### Example 3-4 Use of Plasma-Treated Hollow Spheres and Compatibilizer

In Example 3-4, the surfaces of the same hollow spheres as used in Example 3-1 was treated with plasma ions to modify the surfaces of the hollow spheres, and then the surface-modified hollow spheres were compounded along with a polypropylene (PP) resin and a compatibilizer to thereby manufacture a composite material of the light diffusing plate.

Specifically, in order to covalently bond the interface between the hydrophobic PP and the hollow spheres having a polar group, the surfaces of the hollow spheres were subjected to plasma treatment with a plasma processor (Applasma) so as to modify the surfaces of the hollow spheres.

PP (90 wt %) and modified PP (2 wt %) were placed in the main hopper, and 8 wt % of the surface-modified hollow spheres were placed in the side feeder hopper, respectively, and compounded, and the resultant was cut into strands with a length of 100 mm and cooled in liquid nitrogen fractured, and their cross-sections were observed for covalent bonding with a scanning electron microscope (SEM).

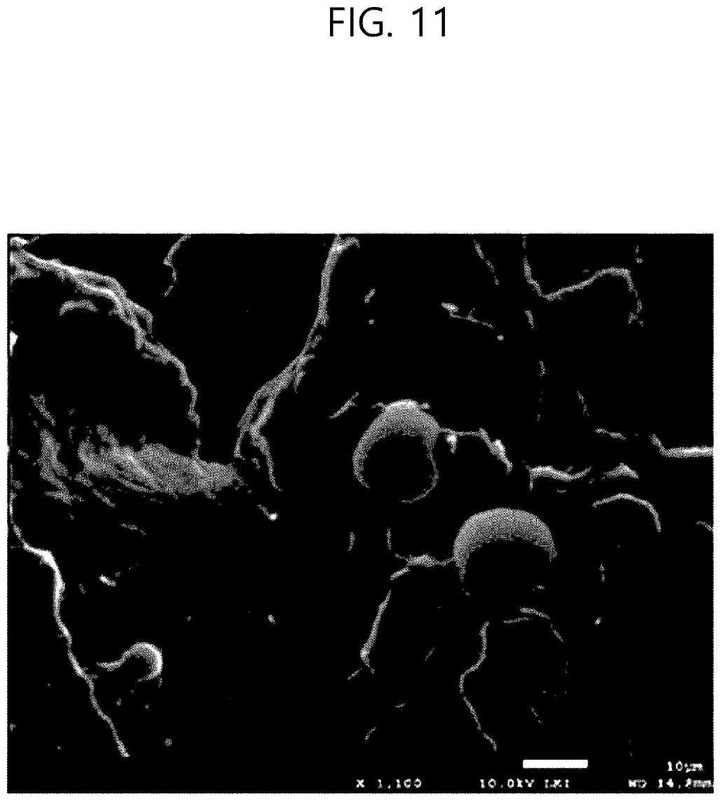

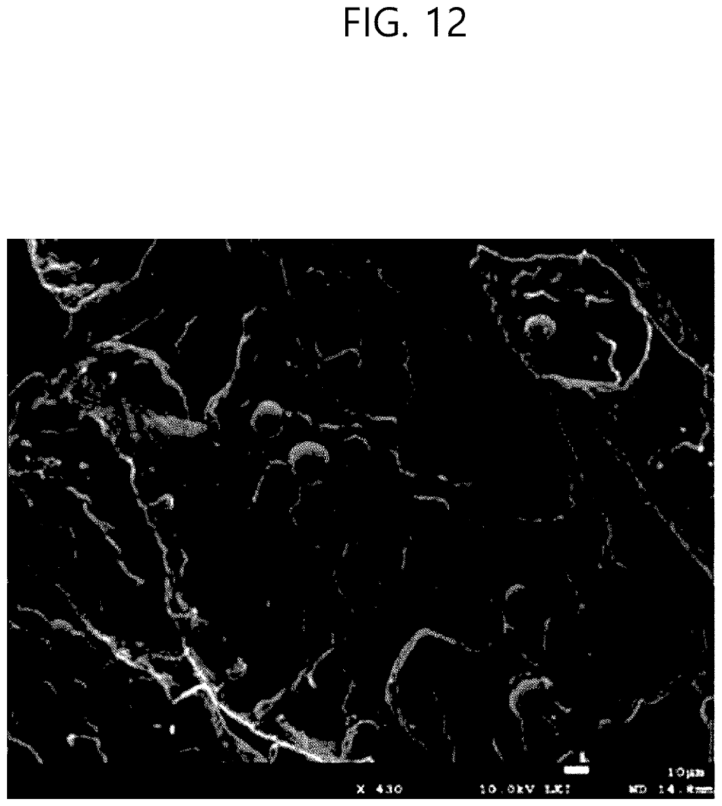

As illustrated in FIGS. 11 and 12, it was confirmed that the covalent bonding was well formed between the hollow sphere and the PP resin.

Five tensile specimens were manufactured from the composite materials prepared according to ASTM D638 standard through an injection machine, respectively, and after placing them at room temperature for 48 hours, their tensile strength was measured using a tensile tester (UTM), and the average value was obtained.

### Example 3-5 Plasma-Treated Hollow Spheres and Non-Use of Compatibilizer

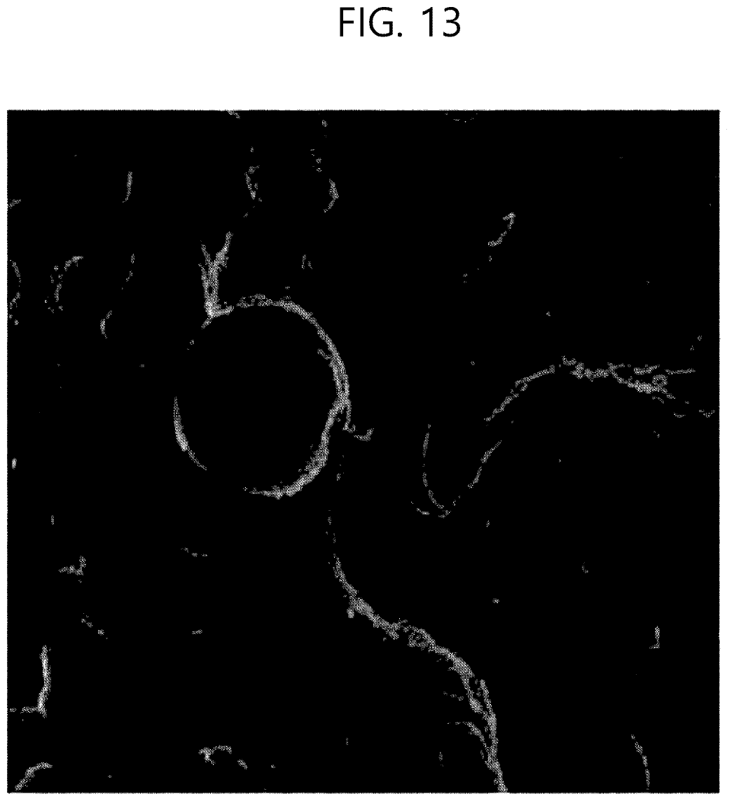

In Example 3-5, the surfaces of the hollow spheres were treated with plasma ions to modify the surfaces of the hollow spheres in the same manner as in Example 3-4, and then the surface-modified hollow spheres were compounded only with a polypropylene (PP) resin without using a compatibilizer to thereby prepare a composite material for the light diffusing plate. FIG. 13 is a cross-section image of strands of 100 mm in length, cooled in liquid nitrogen and fractured, and observed with a scanning electron microscope (SEM).

### Comparative Example Single Use Between Unmodified Hollow Spheres and PP Resin

The hollow spheres used in this comparative example were the same as those used in Examples 3-1 to 3-3, and likewise, Homo H710 (GS Caltex) was used for the PP.

In order to confirm the presence of covalent bonding in the light diffusing plate composition in which the surface-modified hollow spheres were compounded alone with the polypropylene resin, PP (92 wt %) was placed in the main hopper and the hollow spheres (8 wt %) were placed in the side feeder hopper, and compounded, and the resultant was cut into strands with a length of 100 mm, cooled in liquid nitrogen, and fractured, and their cross-sections were observed with a scanning electron microscope (SEM).

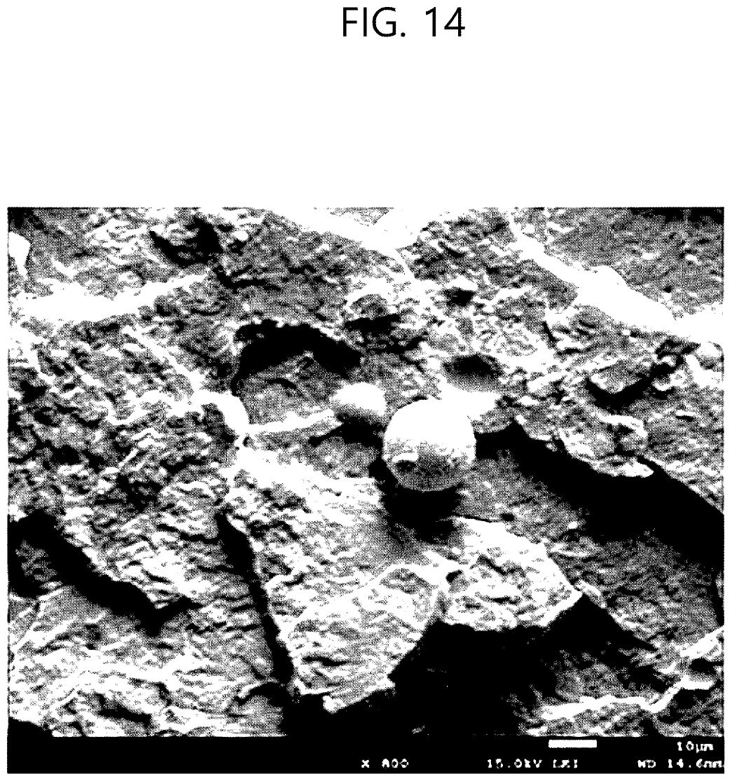

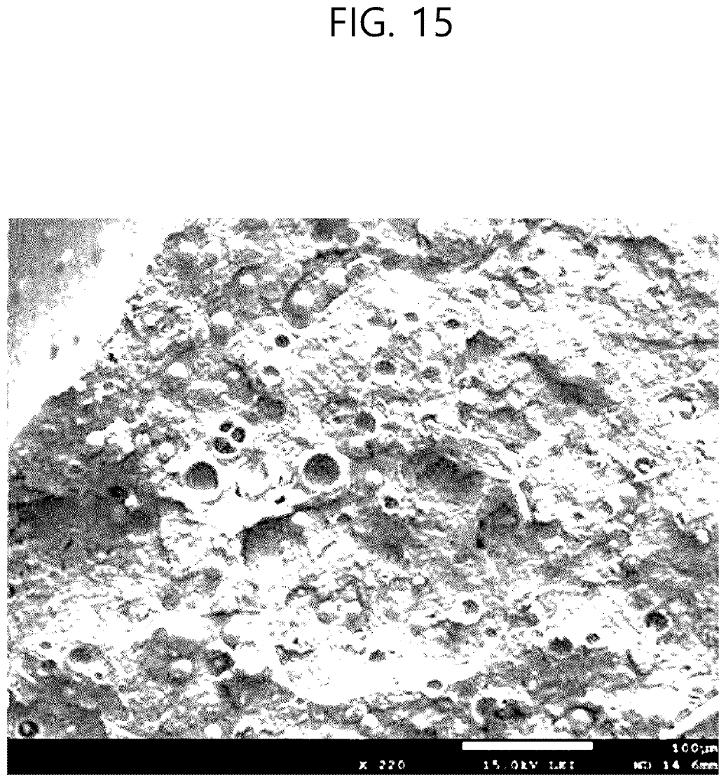

As shown in FIGS. 14 and 15, it was confirmed that covalent bonding was not formed between the hollow spheres and the PP resin.

Five tensile specimens were prepared by injection of the composite material prepared according to ASTM D638 standard, and after placing them at room temperature for 48 hours, their tensile strength was measured using a tensile tester (UTM), and then the average value was obtained.

Table 4 below shows the average values of tensile strength for the tensile specimens of Examples 3-1 to 3-5 and Comparative Example.

TABLE 4

| | H710 | Example | Example | Example | Example | Example | Comparative |
|---|---|---|---|---|---|---|---|
| Test Item | PP | 3-1 | 3-2 | 3-3 | 3-4 | 3-5 | Example |
| Average Tensile | 351.02 | 366.54 | 284.57 | 360.24 | 373.92 | 363.32 | 270.96 |
| Strength (kgf/cm²) | | | | | | | |

As a result of the test, Example 3-4 showed the highest tensile strength, followed by Example 3-1, Example 3-5, Example 3-3, Example 3-2, and Comparative Example. Example 3-1, Example 3-5, and Example 3-3 showed a tensile strength higher than those of H710 PP and Comparative Example, and the presence of covalent bonding was confirmed by SEM images.

Through Examples 3-1, 3-2, 3-3, 3-4, and 3-5 described above, it was confirmed that the covalent bonding between hollow spheres and a PP resin can be implemented through a method of modifying surfaces of the hollow spheres and a method of plasma treatment. In particular, it was confirmed that the strongest covalent bonding force could be obtained when the samples were manufactured by plasma-treatment of the surfaces of the hollow spheres made of a glass material and mixing a compatibilizer with the PP resin as in Example 3-4.

### Test Example 4: Correlation Test Between Glass Transition Temperature and Thermal Expansion of Light Diffusing Plate

This test is a test to confirm the difference in the thermal behavior of the light diffusing plates containing a PP resin and hollow spheres, and it is a test to analyze the correlation between the glass transition temperature (Tg) of the polypropylene composite material containing the hollow spheres and the thermal expansion characteristics of a light diffusing plate.

The test method was conducted by measuring the changes in the glass transition temperature (Tg) with a differential scanning calorimeter (DSC).

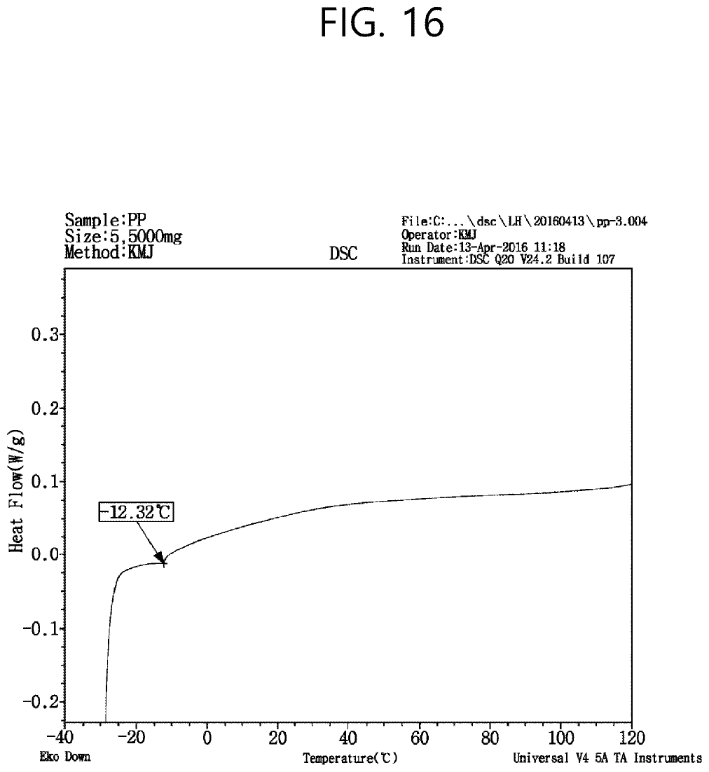

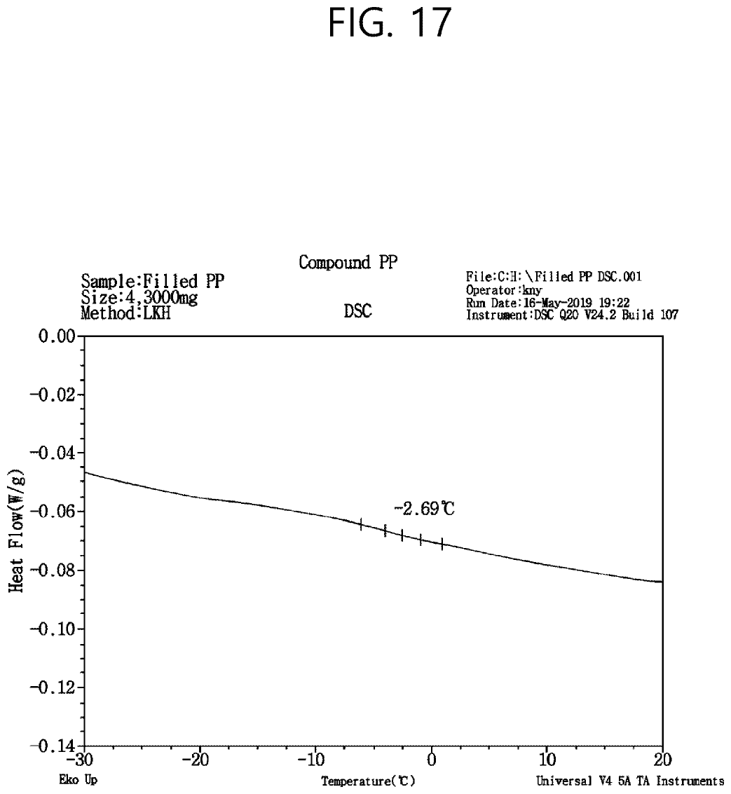

FIG. 16 is a glass transition temperature (Tg) measured with a sample of H710 PP (GS Caltex) and FIG. 17 is a glass transition temperature (Tg) measured with Sample 1-9 of Table 1.

As a result of the test, it can be confirmed that the Tg of the sample of H710 PP was −12.32° C., and the thermal behavior of Sample 1-9 was −2.69° C. As shown in Table 2, it can be seen that Sample 1-9 also has an excellent area expansion rate. Therefore, it could be confirmed that the area expansion rate of the light diffusing plate, in which the hollow spheres were covalently bonded to the PP resin, decreased as the glass transition temperature (Tg) increased.

### Test Example 5: Correlation Between Content (Volume Ratio) of Inorganic Material and Area Expansion Rate of Light Diffusing Plate

From the test results above, it was confirmed that the amount of thermal expansion of the light diffusing plate could be lowered through covalent bonding between the PP resin and the surface-modified hollow spheres. This test was conducted to determine the mixing ratio of the PP resin and the hollow spheres, as another factor for lowering the thermal expansion of the light diffusing plate.

More specifically, a composite material was prepared by filling talc, glass fiber, and hollow spheres, as inorganic materials, in various amounts to a PP resin.

Table 5 shows the specific gravity of each inorganic material.

TABLE 5

| | | | Average Diameter of Hollow | |
|---|---|---|---|---|
| | | GF | Spheres (Outer Diameter) | |
| | Talc | (Glass Fiber) | 30 μm | 40 μm |
| Specific Gravity | 2.78 (g/cm³) | 2.5 (g/cm³) | 0.60 (g/cm³) | 0.38 (g/cm³) |
| (g/cm³) | | | | |

The difference in volume ratio (vol %) according to the weight of the inorganic materials was calculated and compared with the following equation, and the results are shown in Table 5 below.

vol % of inorganic material=(wt % of inorganic materials/density of inorganic materials)/(wt % of inorganic materials/density of inorganic materials+wt % of polymer/density of polymer)

TABLE 6

| | | GF | Average Diameter of Hollow | |
|---|---|---|---|---|
| | | Fiber) | Spheres (Outer Diameter) | |
| Filling Weight | Talc | (Glass | 30 μm | 40 μm |
| Ratio (wt %) | Vol % | | | |
| 1 | 0.32 | 0.36 | 1.34 | 2.33 |
| 2 | 0.65 | 0.73 | 2.97 | 4.40 |
| 3 | 0.99 | 1.10 | 4.43 | 6.82 |
| 4 | 1.33 | 1.47 | 5.88 | 8.98 |
| 8 | 2.74 | 3.03 | 11.53 | 17.07 |

As can be seen from Table 6, the volume ratio (vol %) of the glass fiber at the same weight ratio (wt %) is significantly smaller than the volume ratio (vol %) of the hollow spheres.

The smaller the content of PP resin (which is a material with high thermal expansion), the lower the area expansion rate of the light diffusing plate. As the volume ratio (vol %) of the inorganic materials increases, the volume ratio of the PP resin decreases, thus confirming that the area expansion rate can be lowered.

As shown in Table 2, the reason for the increase of the area expansion rate in the case of the light-diffusing plate specimens of Samples 1-7 and 1-8 containing glass fibers despite the formation of covalent bonding between the glass fibers and the PP resin and the high tensile strength is because the volume ratio ultimately occupied by the glass fibers is ¼ or below compared to that occupied by the hollow spheres in the PP resin, and accordingly the area expansion rate (%) becomes higher. In order to increase the volume ratio of the glass fibers, the weight ratio must be increased; however, this increases the specific gravity of the light diffusing plate which results in lowering productivity and price competitiveness and lowering lower business feasibility from the economical aspect, thus being considered as inappropriate.

In conclusion, it could be confirmed that the area expansion rate is determined by the factor of the covalent bonding between the hollow spheres and the PP resin and the factor of the volume ratio (vol %), rather than the weight ratio (wt %) of the hollow spheres.

### Test Example 6: Dynamic Mechanical Analyzer (DMA) Analysis Test of Light Diffusing Plate Containing Hollow Spheres

This test is a test to confirm the interaction of the PP resin covalently bonded to hollow spheres, and the viscoelastic behavior was measured through the analysis of a dynamic mechanical analyzer (DMA).

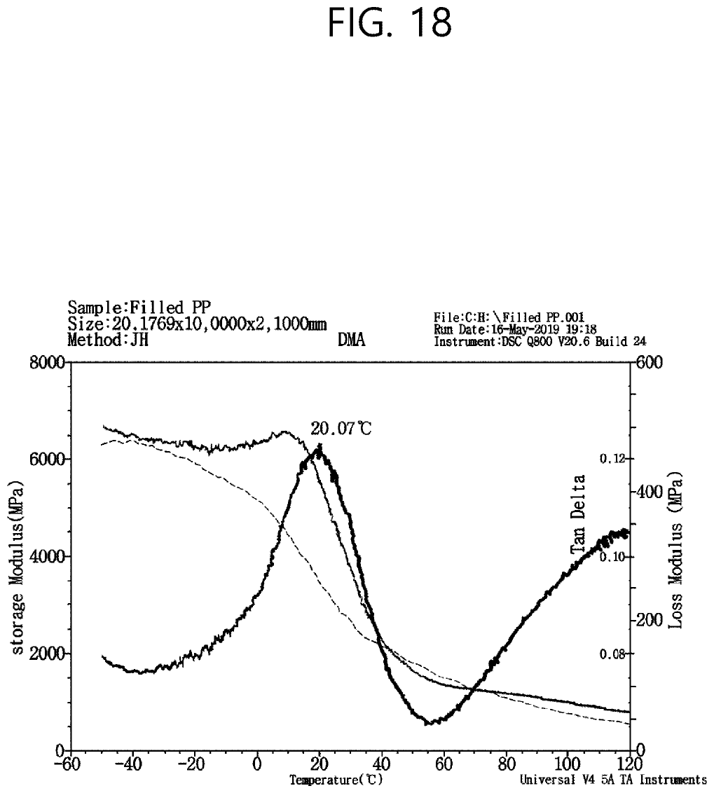

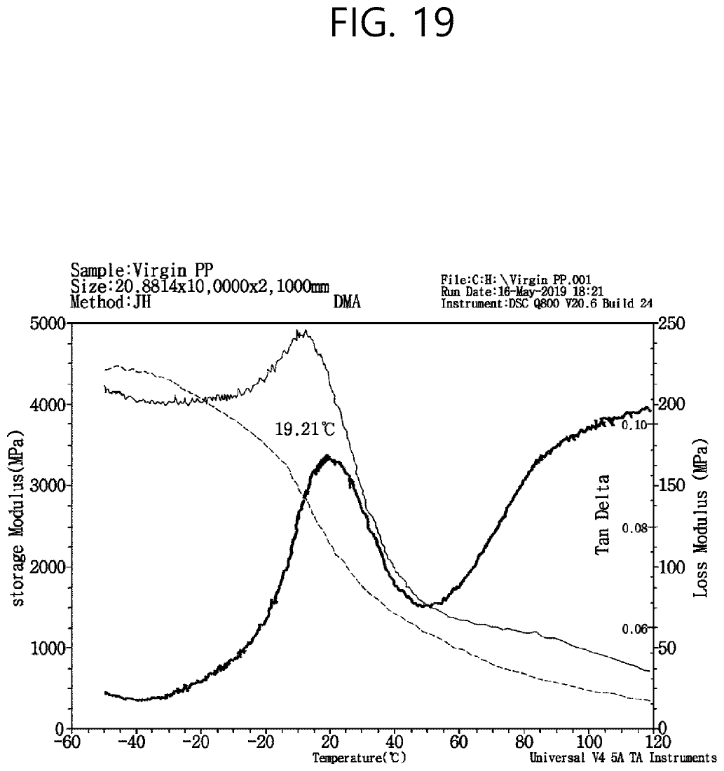

FIG. 18 is a graph illustrating DMA measurement values using Sample 1-9 of Table 1, and FIG. 19 is a graph illustrating DMA measurement values using a sample of H710 PP (GS Caltex).

As a result of the test, the tan delta peak temperature of FIG. 18 was 20.07° C., and the tan delta peak temperature of FIG. 19 was shifted by about 1° C. compared to 20.07° C. In conclusion, the tan delta peak of Sample 1-9 is wider compared to that of PP resin alone. Through this, it can be confirmed that the interaction between the hollow spheres and the PP resin in Sample 1-9 acts by covalent bonding. For reference, the tan delta peak is an indicator of thermal and mechanical conditions that induce bonding, rotation, or intermolecular friction and flow.

### Test Example 7: Test of Actual Area Expansion Rate in Consideration of MD/TD in Extrusion Molding Process of Light Diffusing Plate

As described above, machine direction (MD) and transverse direction (TD) act in an extrusion process; therefore, for the measurement of the thermal expansion of the light diffusing plate, an area expansion rate (which measures the change in a finished product of the extruded light diffusing plate) is being applied rather than applying the standard of the linear expansion coefficient of the material.

With the mixing of Sample 1-9 in Table 2, a composite material of a light diffusing plate covalently bonded to hollow spheres was compounded and mass-produced at 2,000 kg DBChem, and the produced material was produced by way of sheet extrusion at A&P Industry to prepare an original plate of a light diffusing plate with a thickness of 1.5 mm. The prepared original plate was cut to the same size as the current mass-produced PC light diffusing plate (Spolytech) with a display of 55 inches, and the area expansion rate was compared and tested. For the test of area expansion rate (%), the lengths of the long axis and the short axis of the light diffusing plate were measured at room temperature of 23° C. and the respective area was calculated. Thereafter, the temperature of the chamber was set to 60° C., the light diffusing plate was placed into the chamber, and after 72 hours, the lengths of the long axis and the short axis of the light diffusing plate were measured and the respective area was calculated and the area expansion rate was calculated. Table 7 below shows the results of the area expansion rate obtained as described above.

TABLE 7

| | Before Injection into Chamber | | | After Injection into Chamber | | | |
|---|---|---|---|---|---|---|---|
| | (23° C.) | | | (60° C./72 hr) | | | Area |
| | long axis | short axis | area | long axis | short axis | area | Expansion |
| Category | (mm) | (mm) | (mm²) | (mm) | (mm) | (mm²) | Rate (%) |
| PC Light | 1,206.57 | 678.50 | 0.81865 | 1,209.73 | 680.97 | 0.82378 | 0.626 |
| Diffusing | | | | | | | |
| Plate | | | | | | | |
| Sample | 1,206.51 | 683.51 | 0.82466 | 1,209.19 | 686.28 | 0.82984 | 0.628 |
| 1-9 | | | | | | | |

As a result of the test, it was confirmed that the area expansion rate of the light diffusing plate sample 1-9 containing the hollow spheres was equivalent to that of the PC light diffusing plate, which is an existing mass-produced product.

In the above, the present disclosure has been described in detail with reference to the embodiments; however, it is apparent that those of ordinary skill in the art to which the present disclosure pertains may make various substitutions, additions, and modifications within the scope not departing from the technical spirit described above, and it should be understood that such modified embodiments also fall within the protection scope of the present disclosure as defined by the appended claims below.

### INDUSTRIAL APPLICABILITY

The present disclosure can be applied to light diffusing plate of a device using an LED light source, such as LED lighting, an advertisement channel signs for advertisement, displays, etc.

1. A polypropylene composite resin light diffusing plate, which is manufactured in a flat plate shape by mixing a plurality of hollow spheres with a polymer resin containing a polypropylene (PP) resin and a compatibilizer,
wherein the polypropylene (PP) resin and the plurality of hollow spheres are covalently bonded by the compatibilizer, and thus the polypropylene composite resin light diffusing plate has an area expansion rate of 0.4-0.7% at 60° C. relative to an area at room temperature;
wherein the compatibilizer is modified propylene, in which one or more selected from the group consisting of maleic anhydride, acrylic acid, and methacrylic acid is grafted onto a polypropylene resin and having a graft rate of 0.3-1.0%.

2. The polypropylene composite resin light diffusing plate of claim 1, wherein the volume ratio (vol %) of the polymer resin is 82-96 vol %, and the volume ratio (vol %) of hollow spheres is 4-18 vol %.

3. The polypropylene composite resin light diffusing plate of claim 1, wherein the hollow spheres are made of glass beads with a density of 0.3-0.9 g/cm³ and an average outer diameter of 1-300 μm.

4. The polypropylene composite resin light diffusing plate of claim 1, wherein the hollow spheres are surface treated using an aminosilane coupling agent, wherein the aminosilane coupling agent is used at 0.1-0.7 wt % in the hydrolysis process.

5. The polypropylene composite resin light diffusing plate of claim 1, wherein the hollow spheres are plasma surface-treated.
